(19) United States
(12) Patent Application Publication
(10) Pub. No.: US 2006/0074897 A1
(43) Pub. Date: Apr. 6, 2006

(54) System and method for dynamic data masking

(76) Inventor: Iain W. Fergusson, Glasgow (GB)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/957,971

(22) Filed: Oct. 4, 2004

(51) Int. Cl. G06F 17/30

(52) U.S. Cl. 707/4

(57) ABSTRACT

A system and method for dynamically masking data. The system and method receive and identify masked data in a data request, generate a request to receive the corresponding unmasked data, provide the request for unmasked data to a database, receive an unmasked response from the database, mask the response, and return the masked response. The system and method do not alter the database to mask the data it contains and maintain the confidentiality of the sensitive data. Additionally, the system and method receive updates for masked data, generate a corresponding update for unmasked data and apply the unmasked update to the database. The masked and unmasked data updated are held in a data map, and used to remask updated data in response to requests for masked data.

### FIELD OF THE INVENTION

This invention relates to a system and method for dynamically masking data. In particular, this invention pertains to preserving the confidentiality of sensitive data while maintaining the integrity of the original data when testing in a software environment.

### BACKGROUND OF THE INVENTION

Companies are commonly involved in developing new software for their systems as well as providing customer support for problems with their software. Software often uses personal data to complete its processing and provide results. For instance, when purchasing an airline ticket, a computer system may input the traveler's name, address, credit card information and any other personal data needed in order to generate a ticket. Another example is that of a customer requesting banking information. A bank system may require the inquirer's social security number, bank account number, birth date or other sensitive data.

Software developers who write software that uses personal data need to test the new or modified software using realistic personal data. However, companies often do not want to reveal such personal data to software developers. Companies often do not want others to know the personal data that they are protecting due to the potential threat of identity theft. Moreover, companies sometimes outsource the software development to other companies located in other countries, which poses the additional issue of compliance with governmental mandates, such as data privacy laws that restrict the release of personal data. Some industries, such as medical, banking, and insurance, maintain vast amounts of sensitive, personal data whose restricted use is of paramount importance.

Conventional data masking methods preserve the confidentiality of data by modifying the contents of the database before making them available to developers These modifications include: (1) translating selected data fields into an encrypted form, and/or (2) randomly swapping data field values from one record to another. A drawback to using these conventional data masking methods is that they are not a real representation of data that will be used in the software under development. That is, by encrypting and/or swapping the data upfront, the data is permanently corrupted and any relationships between data fields in the database is destroyed. In addition, using encrypted and not “real” data may prove problematic because it may not provide appropriate realistic scenarios. When realistic scenarios are not present, the software may not be tested as robustly as it needs to be tested. Consequently, when the software is employed, errors that went previously undetected may begin surfacing.

Other problems with using conventional data masking methods are, for instance, the time taken to encrypt an entire database—which may be hours or days. Most of the data may then never be used, making the effort to encrypt it an unnecessary overhead. A further problem is that of referential integrity—the feature of databases whereby values in one table are constrained to be in a list of valid values in another table. The existence of these constraints may mean that encrypting one table would violate the constraints in the other table. To correct for this when encrypting a database, data from several tables may have to be extracted, encrypted and stored back into the tables, rather than being converted in-situ, thereby increasing the time for the conversion and the complexity of the code required to accomplish it.

A random data generator is another conventional data masking method used. While this method does provide adequate security of data, the use of randomly generated “false” data may also generate false problems—problems that would not be present had the data been more realistic.

There is a need to cure the problems associated with using any of these conventional data masking methods. In particular, there is a need in the art for an effective solution that maintains the security of sensitive data, allows for accurate testing of new and modified software, and does not corrupt the original data.

### SUMMARY OF THE INVENTION

This problem is addressed and a technical solution achieved in the art by a method of using dynamic data masking. According to one aspect of the invention, the method includes masking data after the data is retrieved from the database—not in the database itself where it would then be corrupted. Advantageously, by masking at a later stage than actually in the database itself, the relationship between data in the database tables is preserved and the effort and time required to mask the data may be considerably reduced relative to masking the entire database. According to another aspect of the invention, the data is masked such that the masked data reflects realistic data, but in an encrypted form. Accordingly, problems that may arise during software testing through the use of false data are thereby prevented.

When using a dynamic data masking technique, the software developer or tester sends a request for data. The system then generates a request for all unmasked data needed to construct a masked response and sends this request onto the database to retrieve the uncorrupted, true data response. The system then masks the response and sends it on back to the requestor.

### BRIEF DESCRIPTION OF THE DRAWINGS

A more complete understanding of this invention may be obtained from a consideration of this specification taken in conjunction with the drawings, in which:

FIG. 1 is a diagram illustrating a computer system according to an exemplary embodiment of the present invention;

FIG. 2 is a flow chart illustrating a process flow for handling standard requests according to the exemplary embodiment; and

FIG. 3 is a flow chart illustrating a process flow for handling update requests according to the exemplary embodiment.

### DETAILED DESCRIPTION OF THE EXEMPLARY EMBODIMENT OF THE INVENTION

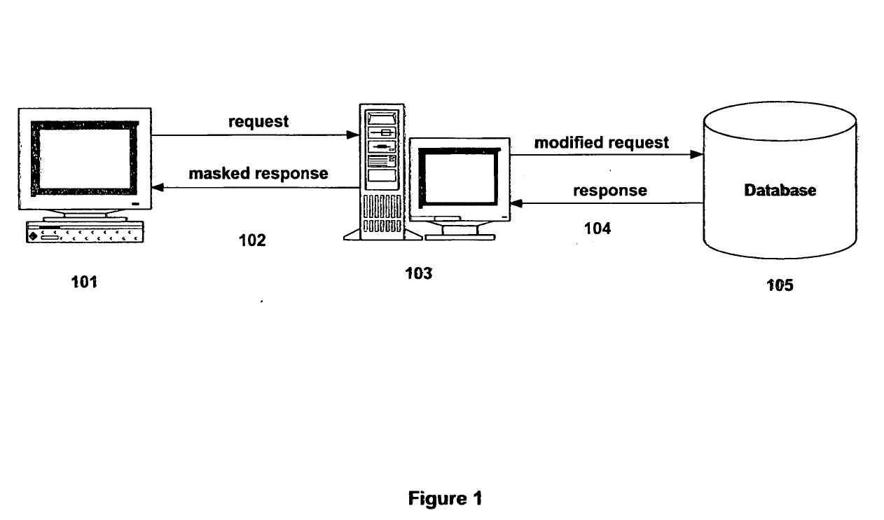

The exemplary embodiment of the present invention will be described with reference to FIG. 1, which depicts an exemplary computer hardware arrangement implementing the present invention's process flows. In FIG. 1, a support computer 101, such as a workstation, is in communication via communication link 102 with server computer 103. Server computer 103 is in communication with database 105 via communication link 104. The combination of server computer 103 and database 105 are often referred to herein as the “system”. Support computer 101 and server computer 103 can be a desktop computer, or any other type of computer such as a laptop, hand-held device, or any device that includes a computer. In the exemplary embodiment, support computer 101 belongs to an outside software testing contractor from whom confidential information in database 105 must be protected. Although shown separate from server computer 103, one skilled in the art will appreciate that the database 105 may be located within server computer 103 on a computer-readable memory, or within another computer communicatively connected to server computer 103. In addition, one skilled in the art will appreciate that the database 105 may be a database or any data storage system. Further, any method of communication known in the art between computers may be used between support computer 101, server computer 103, and any other computer containing database 105. Communication links 102 and 104 need not be a hardwired network, and may be wireless, or a combination of both.

With reference to FIG. 1, an overview of the data flow according to the exemplary embodiment will now be described. First, the user, a software developer or tester who is working at support computer 101, sends a request to server computer 103 for data via communication link 102. Support computer 101 can be located on-site, off-site or even in a foreign country. The request from support computer 101 is analyzed to determine if it is a request that contains a masked data field. If so, server computer 103 generates a request for the corresponding unmasked data needed to construct a response. Server computer then sends the generated or “modified” request on to database 105 for processing via communication link 104. Database 105 returns the unmasked response to server computer 103 via communication link 104. Server computer 103 then determines what data should be returned in response to the original request, masks the data in the response accordingly, and sends the masked response on to support computer 101 via communication link 102.

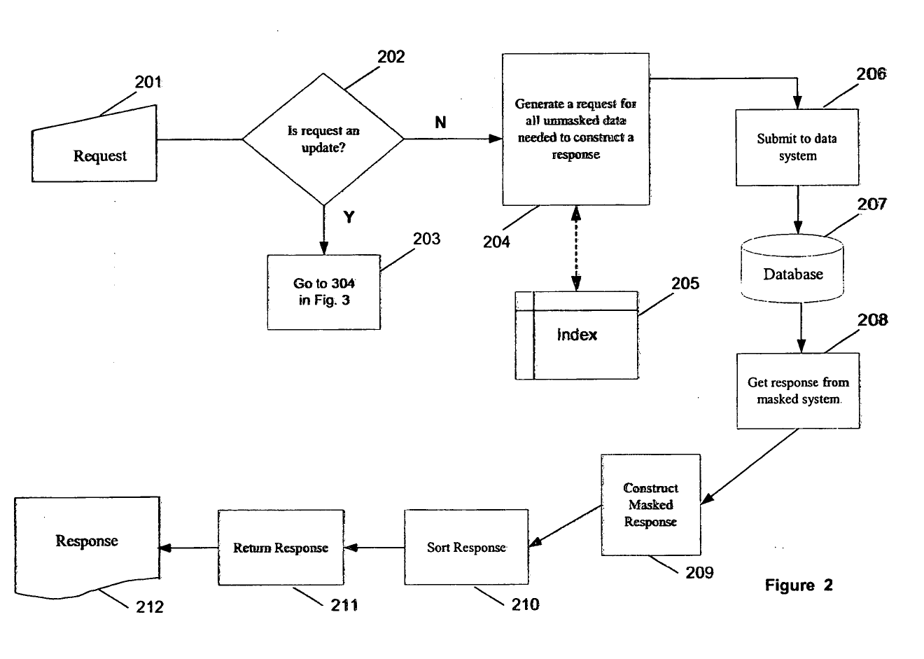

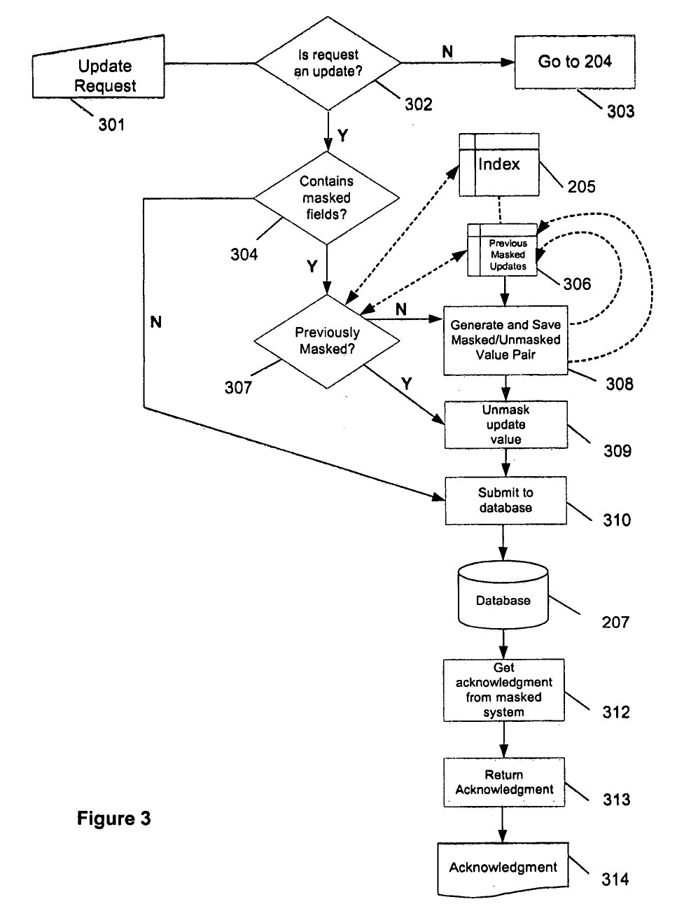

The process flow according to the exemplary embodiment will now be described in detail with reference to FIG. 2, which illustrates an aspect of the processing performed by server computer 103. At block 201, the process begins with support computer 101 requesting data in order to, for example, test new or modified software or provide customer support. At block 202, server computer 103 determines if the request is an update, i.e., is the request specifying that data should be written to database 105. If so, the process will be further described in detail with reference to FIG. 3 as stated in block 203. If not, at block 204, the server computer 103 determines if the data request contains any complete data values or partial data values for fields which are masked. This determination may occur by accessing a table that identifies which data fields are masked. For instance, this table may specify that purchaser names are masked and, therefore, if the request includes such a field, the request is determined to contain masked information. An example of such a table is provided below in Table I:

TABLE I

Masked Fields
Purchaser Name
Social Security Number
Address

If the data request does not contain any data values or partial data values for masked fields, the data request may be submitted unchanged at block 206 to database 207, which corresponds to database 105 in FIG. 1. Because an advantage of the invention is that database 207 need not be changed, it is crucial that database 207 always receives unmasked requests at block 206 and always returns the requested information in unmasked form at block 208. Because the original request did not contain masked information in this case, the unmasked response from database 207 is left as is. In other words, if the original request does not pertain to any information that should be masked, then nothing occurs at 209.

If the system determines, by query, that the result should be sorted, the response data is then sorted at block 210. For example, if the query is: “List all stock symbols in alphabetical order that begin with the letter A,” the server computer 103 would then sort all the returned unmasked stock symbols masked at 209 into alphabetical order. At block 211, the system returns the response 212 from the database 207 to the user.

If, at block 204, server computer 103 determines that the data request contains a complete data value for a masked field, this data value must be unmasked. Unmasking may be achieved by parsing the request into its constituent data elements and matching the data elements in the request with data in data map index 205. The data map index 205 includes a list of masked data values and their associated unmasked counterparts. The masked data values in the request are unmasked by finding their counterpart in data map index 205. For example, a request might be “List all orders with purchaser name equal to “Ki3axZoa.” The data map index 205 may appear as shown in Table II below:

TABLE II

| Masked Purchaser | Unmasked Purchaser |
|---|---|
| Ki3axZoa | John Smith |
| Plzkkoca | Jane Doe |
| Xavkp | Bank X |
| Ki3zfx3b | James Allen |

Although described as an “index” any data storage structure or device may be used to store the index 205. At block 204, the data value “Ki3axZoa” of the request would be found as a masked purchaser in the data map index 205 and would be unmasked to reveal “John Smith.”

It is with the index 205 that data type rules may be enforced. If it is necessary for proper testing that all purchaser names be in string format and that all order amounts be in currency format, it may be required that the masked versions of these data fields in index 205 be of the proper data type. Any encryption technique known in the art to produce the appropriate masked versions of these data fields may be used. While data masking according to the invention can be implemented using a variety of procedural programming languages such as C++ and Java, using a rules-based software language proves advantageous. It is preferable to use a rules based language because it simplifies modifications to the masking application.

The modified request is submitted to database 207 at block 206. As shown in block 208, the database fulfills the data request in an unmasked manner. As per the example, the database returns all orders with purchaser name “John Smith.” At block 209, the response is masked by reviewing the index 205 conversely. In this case, “John Smith” is masked to “Ki3axZoa” using Table II.

The system may also choose to mask additional information currently unmasked in the data response. For example, the data response may mask sums of money, dates, and/or stock purchases in John Smith's order list. Which fields are masked are determined by rules held in the system and which may be stored in index 205. For example, a simple rule might be “The number of shares purchased in a fulfilled order transaction will always be masked to 99.” This rule would be defined once in the system and used to mask any response that included “the number of shares purchased in a fulfilled order transaction,” or data derived from that number such as totals or averages.

It may be advantageous to also mask positional relationships between data at 209. It is important to mask relationships because the content of masked data may be determinable by the relationships between masked and unmasked data. For example, a purchaser's name may be masked but not its region or purchase amount, thereby allowing for potential determination of the purchaser based on a review of the unmasked fields. To elaborate, if a purchaser makes a significant purchase in New York, a user may be able to determine who the purchaser is if few people have made significant purchases in New York. Accordingly, if the implementer considers it necessary to mask a particular relationship, the system could have rules defined based on the data being masked. For example, a positional rule could be set such as: anytime a purchase amount is within the top 20% of all purchase amounts within a predetermined period, replace it (i.e., mask it) by dividing it by two, and store the new masked value, along with its unmasked counterpart, in the index 205. Otherwise, leave it unmasked.

Once the response is masked at 209, it is sorted at 210. At 211, the response 212 is transmitted to support computer 101.

If, at block 204, the server computer 103 determines that the request contains a partial data value for a masked field, a range of solutions may be applied. An example of a partial data value for a masked field is if the user requests “Select all orders received yesterday where the purchaser name starts with ‘Ki3”’, where “Ki3” is a portion of a masked purchaser name. Referring to Table II, “Ki3” may represent the masked version of purchasers John Smith or James Allen.

One of the example solutions to this problem is useful for requests that are likely to retrieve a small amount of data. This solution leaves the partially identified field masked, and retrieves and encrypts all data in the database 207 corresponding to the field queried. To continue with the purchaser name example, the partially identified purchaser name in the request, i.e., “Ki3”, is removed in its encrypted form at block 204 and saved for later use at 209. Then, all purchaser names from the database 207 are retrieved. All retrieved purchaser names are then masked at 209. Again at block 209, once encrypted, the masked purchaser names are reviewed to determine if they match the partially identified masked purchaser name previously removed from the user's request. For example, only masked purchaser names beginning with “Ki3” are selected. Any required sorting occurs at step 210, and the response is and returned to the user at step 211.

The second example solution is useful for queries that are likely to retrieve a large amount of data. This solution compares the partial data value for the masked field in the query to the index 205 to determine, for example, which purchaser names meet the request. The purchaser names from index 205 that fulfill the request are unmasked and only the unmasked purchaser names are submitted to the database 207.

Referring to Table II as an example, at block 204, where the user wants to “select all orders where the purchaser name starts with ‘Ki3’,” the data element “Ki3” of the request is found as a masked purchaser in the data map index 205. The data elements “Ki3axZoa” and “Ki3zfx3b” are unmasked to reveal purchasers “John Smith” and “James Allen”, respectively, and are submitted to the database 207. As shown in block 208, the database fulfills the data request in an unmasked manner. As per the example, the database returns all orders for purchasers John Smith and James Allen. At block 209, the internal system masks the data response by reviewing the data map index 205 conversely to create a masked mapping for John Smith and James Allen—in this case, “Ki3axZoa” and “Ki3zfx3b”, respectively. The system may also choose to mask additional information currently unmasked in the data response. As previously discussed, rules held by the system would determine additional masked fields. Block 210 sorts the response if necessary and at block 211, the masked data response 212 is returned to the user's support computer 101.

Another aspect of the process flow according to the exemplary embodiment will now be described in detail with reference to FIG. 3, which illustrates the processing performed by support computer 103 for an update request. An update request is one that specifies that a field in database 207 should be changed. An example of an update request is “Change the purchaser name for order 1234 to ‘ABC’.” In all cases, the system first determines if request 301 is an update at block 302. If not, as seen in block 303, the process flow continues at block 204 as previously described in FIG. 2. If the system determines that the request is for an update, the system then determines if the update pertains to a masked field at block 304. If not, processing proceeds directly to block 310 where the request is submitted to database 207. Optionally, at step 312, an acknowledgement that the update is complete is received. This acknowledgement 314 is then returned to the user's support computer at step 313.

If the update request pertains to a masked field, it is determined whether the masked value in the update request is new to the system at block 307. To do this, the system searches both the data map index 205 and a Previous Masked Updates table 306 to see if they include the masked data value—“ABC” in this example. The Previous Masked Updates table 306 may have the same structure as data map index 205 and is a table generated to store related masked and unmasked values that have appeared in previous updates. However, one skilled in the art will appreciate that any storage structure or device may be used to store table 306. The table 306 will be described in more detail below.

If at step 307, the system determines that data map index 205 and Previous Masked Update table 306 contain the masked value, then the masked data value is unmasked at block 309 and submitted to the database 207 at block 310.

If the masked value is not located in the index 305 or the Previous Masked Updates table 306, then it is determined that the masked data value in the update is new to the system, and the system generates an “unmasked” value for the masked value. For example, the system may randomly generate “KLM” for masked value “ABC” at step 308. At step 308, this pair is then saved in the Previous Masked Updates table 306 and the processing continues to step 309 where the masked value is then unmasked because the system can then retrieve its unmasked counterpart from the Previous Masked Updates table 306. This unmasked value then enters the masked system 310 and in database 207, the purchaser name for order 1234 is changed to “KLM,” the counterpart of “ABC”. At step 312, the system acknowledges that the update is complete. This acknowledgment 314 is then returned to the user's support computer 101 at step 313.

This technique is useful in a testing environment. However, in a production environment, a requestor may not be allowed to update database 207 with randomly generated “unmasked” data in order to preserve the integrity of the database 207. An error message of success acknowledgement can still be sent to the user's support computer 101 at step 313.

It is to be understood that the exemplary embodiment is merely illustrative of the present invention and that many variations of the above-described embodiment and example can be devised by one skilled in the art without departing from the scope of the invention. It is therefore intended that all such variations be included within the scope of the following claims and their equivalents.

We claim:

1. A computer implemented method for processing a request, the method comprising:
receiving a request comprising masked data;
identifying the masked data in the request;
unmasking the masked data, thereby producing unmasked data;
generating a modified request from the unmasked data;
submitting the modified request to a database;
receiving an unmasked response to the modified request, the unmasked response comprising data that needs to be masked;
masking the data in the unmasked response that needs to be masked, thereby generating a masked response; and
transmitting the masked response.

2. The method according to claim 1 wherein identifying the masked data in the request comprises accessing a database which identifies masked fields.

3. The method according to claim 2 wherein unmasking the masked data comprises accessing an index.

4. The method according to claim 3 wherein the index comprises a list of masked data and unmasked counterpart data.

5. The method according to claim 4 wherein masking the data in the unmasked response comprises accessing the index of the masked data and unmasked counterpart data.

6. The method according to claim 1 further comprising masking additional data fields in the response by applying a system rule and determining what data fields to mask.

7. The method according to claim 1 further comprising sorting the masked response.

8. A computer implemented method for processing a request, the method comprising:
receiving a request comprising masked data;
identifying a data field corresponding to the masked data;
retrieving data from a database corresponding to the data field, the retrieved data being unmasked;
masking the retrieved data;
generating a response by comparing the masked retrieved data to the request; and
transmitting the response.

9. The method according to claim 8 wherein the masked data in the request partially identifies masked data in an index.

10. The method according to claim 9 wherein retrieving data from the database comprises requesting all unmasked data corresponding to the data field.

11. The method according to claim 8 wherein masking the retrieved data comprises accessing an index comprising masked data and unmasked counterpart data.

12. The method according to claim 8 further comprising determining if the request contains the masked data by accessing a table which identifies masked fields.

13. The method according to claim 8 further comprising masking additional data fields in the response by applying a system rule and determining what data fields to mask.

14. The method according to claim 8 further comprising sorting the response.

15. A computer-implemented method for processing a request, the method comprising:
receiving an update request comprising masked data;
identifying the masked data in the request;
unmasking the masked data thereby producing unmasked data;
generating a modified request from the unmasked data; and
submitting the modified request to a database.

16. The method according to claim 15 further comprising determining if the request is an update.

17. The method according to claim 15 wherein identifying masked data in the request comprises accessing a database which identifies masked fields.

18. The method according to claim 17 wherein unmasking the masked data comprises accessing an index.

19. The method according to claim 17 further comprising unmasking the masked data by accessing a table, the table comprising previously updated masked values and unmasked counterpart data.

20. The method according to claim 15 further comprising determining if the masked data has an unmasked counterpart and generating an unmasked value for the masked data if the masked data does not have an unmasked counterpart.

21. The method according to claim 20 further comprising storing the generated unmasked value and its counterpart masked data in a table.

22. The method of claim 15 further comprising receiving an acknowledgment of the modified request and transmitting the acknowledgment.

23. A system for processing a request, the system comprising:
a database; and
a computer communicatively connected to the database, the computer programmed to perform actions comprising the method of claim 1.

24. A system for processing a request, the system comprising:
a database; and
a computer communicatively connected to the database, the computer programmed to perform actions comprising the method of claim 8.

25. A system for processing a request, the system comprising:
a database; and
a computer communicatively connected to the database, the computer programmed to perform actions comprising the method of claim 15.

26. A computer implemented method for processing a request, the method comprising:
receiving a request comprising a partial masked-data-value;
retrieving data corresponding to the partial masked-data-value from a first database, the first database comprising masked and unmasked data counterparts, the retrieved data being masked;
unmasking the retrieved data;
generating a modified request comprising the unmasked retrieved data;
submitting the modified request to a second database;
receiving a response from the second database; and
transmitting the response.

27. A system for processing a request, the system comprising:
a database; and
a computer communicatively connected to the database, the computer programmed to perform actions comprising the method of claim 26.
